(19) United States
(12) Patent Application Publication
(10) Pub. No.: US 2007/0100563 A1
(43) Pub. Date: May 3, 2007

(54) Probe selection methods, computer program products, systems and arrays

(76) Inventor: Peter G. Webb, Menlo Park, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/377,325

(22) Filed: Mar. 15, 2006

Related U.S. Application Data
(60) Provisional application No. 60/731,370, filed on Oct. 27, 2005.

(51) Int. Cl. G06F 19/00

(52) U.S. Cl. 702/20

(57) ABSTRACT

Probe selection methods, computer program products, systems and arrays are provided. The probes can be used, for example, in genome scanning applications such as array CGH and/or location analysis.

### CROSS-REFERENCING

This patent application claims the benefit of U.S. provisional application Ser. No. 60/731,370, filed Oct. 27, 2005, which provisional application is incorporated by reference in its entirety for all purposes.

### BACKGROUND

For certain types of chemical array-based assays, it is desirable to scan large regions of the genome in a single assay. For example, in comparative genome hybridization assays performed using an array (aCGH) or in location analysis in which DNA binding factor binding sites are evaluated, it may be desirable to evaluate a whole genome at a time. Probe representation on an array may thus limit the throughput of the analysis.

### SUMMARY OF THE INVENTION

Methods for designing and identifying probes for array-based assays are provided according to embodiments of the invention. In certain aspects, the assays are genome scanning assays, such as aCGH and/or location analysis assays.

The invention additionally provides computer program products for implementing the methods, systems for executing the computer program products, and probe sets and arrays designed using the methods.

A method for selecting a set of genomic probes is provided. This method may include: a) weighting regions of a chromosomal segment that contain a feature to produce a weight-adjusted map of the chromosomal segment; and b) selecting a set of probes for said at least part of a genome using said weight-adjusted map. The set of genomic probes may be selected such that regions having a higher weighting are associated with a higher density of genomic probes than regions having a lower weighting.

In certain embodiments, the set of genomic probes may selected from an initial probe set that containing a larger number of probes than the set of genomic probes.

The set of genomic probes is selected from the initial probe set using a pairwise probe elimination method.

The feature may be a regulatory feature, e.g., a CpG island or promoter region, or a transcribed or coding sequence, e.g., an miRNA coding sequence, an EST coding sequence, an exon encoding a known cDNA, or a predicted exon.

In certain embodiments, the regions may individually weighted according to the strength of evidence indicating a genomic feature at that region.

The at least part of a genome may be 1 Mb or longer of a genome.

A computer-readable medium comprising programming for performing the above method is also provided.

In certain embodiments, the computer readable medium may contain instructions for: a) weighting regions of a genome segment that contain a feature; b) identifying probes that detect the genome segment; c) calculating the physical distances between probes in neighboring probe pairs; d) adjusting the calculated distances between the probes in the neighboring probe pairs according to the weighting of the region to which a probe pair binds to produce a set of weight-biased distances; e) selecting the neighboring probe pair associated with the least weight-biased distance; f) eliminating the lower ranked probe of the selected probe pair; and g) repeating acts e) to f) until a desired number of candidate probes have been eliminated.

Also provided is a computer system comprising the computer readable medium.

A computer-based method for selecting a set of genomic probes is also provided. This method may comprising the following acts: inputting information about a feature of a chromosomal segment using a computer interface; and executing computer readable instructions for performing the above method. The executing act is done locally to the inputting act, or done at a remote location to the inputting act. The method may further include retrieving information from a location that is remote to the locations in which the inputting and executing acts are performed.

In certain embodiments, the inputting includes specifying a type of feature, and the method further includes retrieving from a third party database information on a plurality of features of the specified type.

In other embodiments, the inputting includes specifying a type of feature and a chromosomal segment, and said method produces a set of genomic probes for a plurality of features of the specified type in said chromosomal segment.

The regions may each comprise a feature and flanking sequences at either side of the feature.

The inputting act may include selecting the pre-determined sequence determination using a graphical computer interface.

The method may further include receiving information on the set of genomic probes.

The method may further include receiving an array containing the set of genomic probes.

A method of making an array is also provided. This method may include: a) selecting a set of genomic probes according to the above method; and b) fabricating an array comprising the set of genomic probes. An array made by this method is also provided.

Also provided is a method comprising: making an array according to the above method, contacting the array with a population of labeled nucleic acids; and reading the array to produce data.

### BRIEF DESCRIPTION OF THE DRAWINGS

The objects and features of the invention can be better understood with reference to the following detailed description and accompanying drawing.

FIG. 1 schematically illustrates a first embodiment of a probe selection method.

FIG. 2 schematically illustrates a second embodiment of a probe selection method.

FIGS. 3 and 4 are flow charts illustrating steps of a method of probe selection according to one aspect of the invention.

FIG. 5 is a schematic diagram illustrating a process of a method of probe selection according to an aspect of the invention.

FIGS. 6A-6F show representations of probes identified using methods according to aspects of the invention.

### DESCRIPTION

Before describing the present invention in detail, it is to be understood that this invention is not limited to specific method steps, arrays, or equipment, as such may vary. It is also to be understood that the terminology used herein is for the purpose of describing particular embodiments only, and is not intended to be limiting. Methods recited herein may be carried out in any order of the recited events that is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

Unless defined otherwise below, all technical and scientific terms used herein have the same meaning as commonly understood by one of ordinary skill in the art to which this invention belongs. Still, certain elements are defined herein for the sake of clarity.

All publications mentioned herein are incorporated herein by reference to disclose and describe the methods and/or materials in connection with which the publications are cited.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

It must be noted that, as used in this specification and the appended claims, the singular forms “a”, “an” and “the” include plural referents unless the context clearly dictates otherwise. Thus, for example, reference to “a biopolymer” includes more than one biopolymer, and reference to “a voltage source” includes a plurality of voltage sources and the like.

Definitions

The following definitions are provided for specific terms that are used in the following written description.

A “biopolymer” is a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. As such, this term includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. Specifically, a “biopolymer” includes deoxyribonucleic acid or DNA (including cDNA), ribonucleic acid or RNA and oligonucleotides, regardless of the source.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “mRNA” means messenger RNA.

A “biomonomer” references a single unit, which can be linked with the same or other biomonomers to form a biopolymer (for example, a single amino acid or nucleotide with two linking groups one or both of which may have removable protecting groups). A biomonomer fluid or biopolymer fluid reference a liquid containing either a biomonomer or biopolymer, respectively (typically in solution).

A “nucleotide” refers to a sub-unit of a nucleic acid and has a phosphate group, a carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. Nucleotide sub-units of deoxyribonucleic acids are deoxyribonucleotides, and nucleotide sub-units of ribonucleic acids are ribonucleotides.

An “oligonucleotide” generally refers to a nucleotide multimer of about 10 to about 200 nucleotides in length, while a “polynucleotide” includes a nucleotide multimer having any number of nucleotides.

A chemical “array”, unless a contrary intention appears, includes any one, two or three-dimensional arrangement of addressable regions bearing a particular chemical moiety or moieties (for example, biopolymers such as polynucleotide sequences) associated with that region, where the chemical moiety or moieties are immobilized on the surface in that region. By “immobilized” is meant that the moiety or moieties are stably associated with the substrate surface in the region, such that they do not separate from the region under conditions of using the array, e.g., hybridization and washing and stripping conditions. As is known in the art, the moiety or moieties may be covalently or non-covalently bound to the surface in the region. For example, each region may extend into a third dimension in the case where the substrate is porous while not having any substantial third dimension measurement (thickness) in the case where the substrate is non-porous. An array may contain more than ten, more than one hundred, more than one thousand more than ten thousand features, or even more than one hundred thousand features, in an area of less than 20 cm² or even less than 10 cm². For example, features may have widths (that is, diameter, for a round spot) in the range of from about 10 μm to about 1.0 cm. In other embodiments each feature may have a width in the range of about 1.0 μm to about 1.0 mm, such as from about 5.0 μm to about 500 μm, and including from about 10 μm to about 200 μm. Non-round features may have area ranges equivalent to that of circular features with the foregoing width (diameter) ranges. A given feature is made up of chemical moieties, e.g., nucleic acids, that bind to (e.g., hybridize to) the same target (e.g., target nucleic acid), such that a given feature corresponds to a particular target. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide. Such interfeature areas typically will be present where the arrays are formed by processes involving drop deposition of reagents but may not be present when, for example, light directed synthesis fabrication processes are used. It will be appreciated though, that the interfeature areas, when present, could be of various sizes and configurations. An array is “addressable” in that it has multiple regions (sometimes referenced as “features” or “spots” of the array) of different moieties (for example, different polynucleotide sequences) such that a region at a particular predetermined location (an “address”) on the array will detect a particular target or class of targets (although a feature may incidentally detect non-targets of that feature). The target for which each feature is specific is, in representative embodiments, known. An array feature is generally homogenous in composition and concentration and the features may be separated by intervening spaces (although arrays without such separation can be fabricated).

In the case of an array, the “target” will be referenced as a moiety in a mobile phase (typically fluid), to be detected by probes (“target probes”) which are bound to the substrate at the various regions. However, either of the “target” or “target probes” may be the one which is to be detected by the other (thus, either one could be an unknown mixture of polynucleotides to be detected by binding with the other). “Addressable sets of probes” and analogous terms refer to the multiple regions of different moieties supported by or intended to be supported by the array surface.

The term “sample” as used herein relates to a material or mixture of materials, containing one or more components of interest. Samples include, but are not limited to, samples obtained from an organism or from the environment (e.g., a soil sample, water sample, etc.) and may be directly obtained from a source (e.g., such as a biopsy or from a tumor) or indirectly obtained e.g., after culturing and/or one or more processing steps. In one embodiments, samples are a complex mixture of molecules, e.g., comprising at least about 50 different molecules, at least about 100 different molecules, at least about 200 different molecules, at least about 500 different molecules, at least about 1000 different molecules, at least about 5000 different molecules, at least about 10,000 molecules, etc.

The term “genome” refers to all nucleic acid sequences (coding and non-coding) and elements present in any virus, single cell (prokaryote and eukaryote) or each cell type in a metazoan organism. The term genome also applies to any naturally occurring or induced variation of these sequences that may be present in a mutant or disease variant of any virus or cell type. These sequences include, but are not limited to, those involved in the maintenance, replication, segregation, and higher order structures (e.g. folding and compaction of DNA in chromatin and chromosomes), or other functions, if any, of the nucleic acids as well as all the coding regions and their corresponding regulatory elements needed to produce and maintain each particle, cell or cell type in a given organism.

For example, the human genome consists of approximately 3.0×10⁹ base pairs of DNA organized into distinct chromosomes. The genome of a normal diploid somatic human cell consists of 22 pairs of autosomes (chromosomes 1 to 22) and either chromosomes X and Y (males) or a pair of chromosome Xs (female) for a total of 46 chromosomes. A genome of a cancer cell may contain variable numbers of each chromosome in addition to deletions, rearrangements and amplification of any subchromosomal region or DNA sequence. In certain aspects, a “genome” refers to nuclear nucleic acids, excluding mitochondrial nucleic acids; however, in other aspects, the term does not exclude mitochondrial nucleic acids. In still other aspects, the “mitochondrial genome” is used to refer specifically to nucleic acids found in mitochondrial fractions.

By “genomic source” is meant the initial nucleic acids that are used as the original nucleic acid source from which the probe nucleic acids are produced, e.g., as a template in the nucleic acid amplification and/or labeling protocols.

If a surface-bound polynucleotide or probe “corresponds to” a chromosomal region, the polynucleotide usually contains a sequence of nucleic acids that is unique to that chromosomal region (i.e., sufficiently different in sequence from a sequence on another chromosome so that a probe comprising the sequence would specifically hybridize to the chromosome to which it corresponds and not to another chromosome under stringent hybridization conditions). Accordingly, a surface-bound polynucleotide that corresponds to a particular chromosomal region usually specifically hybridizes to a labeled nucleic acid made from that chromosomal region, relative to labeled nucleic acids made from other chromosomal regions.

An “array layout” or “array characteristics”, refers to one or more physical, chemical or biological characteristics of the array, such as positioning of some or all the features within the array and on a substrate, one or more feature dimensions, or some indication of an identity or function (for example, chemical or biological) of a moiety at a given location, or how the array should be handled (for example, conditions under which the array is exposed to a sample, or array reading specifications or controls following sample exposure).

The phrase “oligonucleotide bound to a surface of a solid support” or “probe bound to a solid support” or a “target bound to a solid support” refers to an oligonucleotide or mimetic thereof, e.g., PNA, LNA or UNA molecule that is immobilized on a surface of a solid substrate, where the substrate can have a variety of configurations, e.g., a sheet, bead, particle, slide, wafer, web, fiber, tube, capillary, microfluidic channel or reservoir, or other structure. In certain embodiments, the collections of oligonucleotide elements employed herein are present on a surface of the same planar support, e.g., in the form of an array. It should be understood that the terms “probe” and “target” are relative terms and that a molecule considered as a probe in certain assays may function as a target in other assays.

As used herein, a “test nucleic acid sample” or “test nucleic acids” refer to nucleic acids comprising sequences whose quantity or degree of representation (e.g., copy number) or sequence identity is being assayed. Similarly, “test genomic acids” or a “test genomic sample” refers to genomic nucleic acids comprising sequences whose quantity or degree of representation (e.g., copy number) or sequence identity is being assayed.

As used herein, a “reference nucleic acid sample” or “reference nucleic acids” refers to nucleic acids comprising sequences whose quantity or degree of representation (e.g., copy number) or sequence identity is known. Similarly, “reference genomic acids” or a “reference genomic sample” refers to genomic nucleic acids comprising sequences whose quantity or degree of representation (e.g., copy number) or sequence identity is known. A “reference nucleic acid sample” may be derived independently from a “test nucleic acid sample,” i.e., the samples can be obtained from different organisms or different cell populations of the sample organism. However, in certain embodiments, a reference nucleic acid is present in a “test nucleic acid sample” which comprises one or more sequences whose quantity or identity or degree of representation in the sample is unknown while containing one or more sequences (the reference sequences) whose quantity or identity or degree of representation in the sample is known. The reference nucleic acid may be naturally present in a sample (e.g., present in the cell from which the sample was obtained) or may be added to or spiked in the sample.

If a surface-bound polynucleotide or probe “corresponds to” a chromosome, the polynucleotide usually contains a sequence of nucleic acids that is unique to that chromosome. Accordingly, a surface-bound polynucleotide that corresponds to a particular chromosome usually specifically hybridizes to a labeled nucleic acid made from that chromosome, relative to labeled nucleic acids made from other chromosomes. Array features, because they usually contain surface-bound polynucleotides, can also correspond to a chromosome.

A “non-cellular chromosome composition” is a composition of chromosomes synthesized by mixing pre-determined amounts of individual chromosomes. These synthetic compositions can include selected concentrations and ratios of chromosomes that do not naturally occur in a cell, including any cell grown in tissue culture. Non-cellular chromosome compositions may contain more than an entire complement of chromosomes from a cell, and, as such, may include extra copies of one or more chromosomes from that cell. Non-cellular chromosome compositions may also contain less than the entire complement of chromosomes from a cell.

“Hybridizing” and “binding”, with respect to polynucleotides, are used herein interchangeably.

The term “duplex Tm” refers to the melting temperature of two oligonucleotides that have formed a duplex structure.

By “normalization” is meant that data corresponding to the two populations of nucleic acids are globally normalized to each other, and/or normalized to data obtained from controls (e.g., internal controls produce data that are predicted to equal in value in all of the data groups). Normalization generally involves multiplying each numerical value for one data group by a value that allows the direct comparison of those amounts to amounts in a second data group. Several normalization strategies have been described (Quackenbush et al, Nat. Genet. 32 Suppl: 496-501, 2002, Bilban et al Curr Issues Mol. Biol. 4:57-64, 2002, Finkelstein et al, Plant Mol. Biol. 48(1-2):119-31, 2002, and Hegde et al, Biotechniques. 29:548-554, 2000). Specific examples of normalization suitable for use in the subject methods include linear normalization methods, non-linear normalization methods, e.g., using lowest local regression to paired data as a function of signal intensity, signal-dependent non-linear normalization, qspline normalization and spatial normalization, as described in Workman et al., (Genome Biol. 2002 3, 1-16). In certain embodiments, the numerical value associated with a feature signal is converted into a log number, either before or after normalization occurs. Data may be normalized to data obtained using the data obtained from a support-bound polynucleotide for a chromosome of known concentration in any of the chromosome compositions.

The term “predetermined” refers to an element whose identity or composition is known prior to its use. For example, a “predetermined temperature” is a temperature that is specified as a given temperature prior to use. An element may be known by name, sequence, molecular weight, its function, or any other attribute or identifier. As used herein, “automatic”, automatically”, or other like term references a process or series of steps that occurs without further intervention by the user, typically as a result of a triggering event provided or performed by the user.

As used herein, the term “signal” refers to the detectable characteristic of a detectable molecule. Exemplary detectable characteristics include, but are not limited to: a change in the light adsorption characteristics of a reaction solution resulting from enzymatic action of an enzyme attached to a labeling probe acting on a substrate; the color or change in color of a dye; fluorescence; phosphorescence; radioactivity; or any other indicia that can be detected and/or quantified by a detection system being used.

A “scan region” refers to a contiguous (preferably, rectangular) area in which the array spots or features of interest, as defined above, are found or detected. Where fluorescent labels are employed, the scan region is that portion of the total area illuminated from which the resulting fluorescence is detected and recorded. Where other detection protocols are employed, the scan region is that portion of the total area queried from which resulting signal is detected and recorded. For the purposes of this invention and with respect to fluorescent detection embodiments, the scan region includes the entire area of the slide scanned in each pass of the lens, between the first feature of interest, and the last feature of interest, even if there exist intervening areas that lack features of interest.

A “plastic” is any synthetic organic polymer of high molecular weight (for example at least 1,000 grams/mole, or even at least 10,000 or 100,000 grams/mole.

When one item is indicated as being “remote” from another, this descriptor indicates that the two items are in different physical locations, e.g., at least in different buildings, and may be at least one mile, ten miles, or at least one hundred miles apart. When different items are indicated as being “local” to each other they are not remote from one another (for example, they can be in the same building or the same room of a building). “Communicating”, “transmitting” and the like, of information reference conveying data representing information as electrical or optical signals over a suitable communication channel (for example, a private or public network, wired, optical fiber, wireless radio or satellite, or otherwise). Any communication or transmission can be between devices that are local or remote from one another. “Forwarding” an item refers to any means of getting that item from one location to the next, whether by physically transporting that item or using other known methods (where that is possible) and includes, at least in the case of data, physically transporting a medium carrying the data or communicating the data over a communication channel (including electrical, optical, or wireless). “Receiving” something means it is obtained by any possible means, such as delivery of a physical item (for example, an array or array carrying package). When information is received it may be obtained as data as a result of a transmission (such as by electrical or optical signals over any communication channel of a type mentioned herein), or it may be obtained as electrical or optical signals from reading some other medium (such as a magnetic, optical, or solid state storage device) carrying the information. However, when information is received from a communication it is received as a result of a transmission of that information from elsewhere (local or remote).

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly. Items of data are “linked” to one another in a memory when a same data input (for example, filename or directory name or search term) retrieves those items (in a same file or not) or an input of one or more of the linked items retrieves one or more of the others. In particular, when an array layout is “linked” with an identifier for that array, then an input of the identifier into a processor which accesses a memory carrying the linked array layout retrieves the array layout for that array.

As described below, in certain embodiments, the methods according to the invention are coded onto a computer-readable medium in the form of “programming”, where the term “computer readable medium” as used herein refers to any storage or transmission medium that participates in providing instructions and/or data to a computer for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer.

A “computer-based system” refers to the hardware means, software means, and data storage means used to analyze the information of the present invention. The minimum hardware of the computer-based systems of the present invention comprises a central processing unit (CPU), input means, output means, and data storage means. A skilled artisan can readily appreciate that any one of the currently available computer-based system are suitable for use in the present invention. The data storage means may comprise any manufacture comprising a recording of the present information as described above, or a memory access means that can access such a manufacture.

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

A “computer”, “processor” or “processing unit” are used interchangeably and each references any hardware or hardware/software combination which can control components as required to execute recited steps. For example a computer, processor, or processor unit includes a general purpose digital microprocessor suitably programmed to perform all of the steps required of it, or any hardware or hardware/software combination, which will perform those, or equivalent steps. Programming may be accomplished, for example, from a computer readable medium carrying necessary program code (such as a portable storage medium) or by communication from a remote location (such as through a communication channel).

A “memory” or “memory unit” refers to any device that can store information for retrieval as signals by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices). With respect to computer readable media, “permanent memory” refers to memory that is permanent. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RA) is an example of non-permanent memory. A file in permanent memory may be editable and re-writable.

An array “assembly” includes a substrate and at least one chemical array on a surface thereof. Array assemblies may include one or more chemical arrays present on a surface of a device that includes a pedestal supporting a plurality of prongs, e.g., one or more chemical arrays present on a surface of one or more prongs of such a device. An assembly may include other features (such as a housing with a chamber from which the substrate sections can be removed). “Array unit” may be used interchangeably with “array assembly”.

“Reading” signal data from an array refers to the detection of the signal data (such as by a detector) from the array. This data may be saved in a memory (whether for relatively short or longer terms).

A “package” is one or more items (such as an array assembly optionally with other items) all held together (such as by a common wrapping or protective cover or binding). Normally the common wrapping will also be a protective cover (such as a common wrapping or box), which will provide additional protection to items contained in the package from exposure to the external environment. In the case of just a single array assembly a package may be that array assembly with some protective covering over the array assembly (which protective cover may or may not be an additional part of the array unit itself).

It will also be appreciated that throughout the present application, that words such as “cover”, “base” “front”, “back”, “top”, “upper”, and “lower” are used in a relative sense only.

“May” refers to optionally.

When two or more items (for example, elements or processes) are referenced by an alternative “or”, this indicates that either could be present separately or any combination of them could be present together except where the presence of one necessarily excludes the other or others.

Methods

A method for selecting a set of genomic probes for genome analysis arrays, e.g., comparative genome hybridization (CGH) arrays or location analysis arrays is provided. In certain embodiments this method comprises: a) weighting regions of a genome segment that contain a feature to produce a weight-adjusted map of the genome segment; and b) selecting a set of genomic probes for the genome segment using the weight-adjusted map. In particular embodiments, the genomic probes are selected such that they are distributed across the entire genome segment, and regions of the genome segment that have a higher weighting are associated with a higher density of genomic probes than regions having a lower weighting. Genomic probes may be evenly distributed across areas having the same weighting.

The genomic probes may be selected from a larger set of candidate probes. In one embodiment, the probes of the set of candidate probes are scored according to a property, e.g., according to their predicted performance, and candidate probes are selected in such a way as to provide a set of genomic probes for the genomic segment that includes not only the highest ranked probes, but also probes that are distributed in a pattern that is biased towards the regions having a higher weighting.

In certain embodiments, the set of genomic probes may be selected from a set of candidate probes using a pairwise probe elimination method. These embodiments may involve iteratively analyzing neighboring candidate probes that bind to the genomic segment, and eliminating one of the probes from inclusion in the genomic probe set. In certain embodiments, the candidate probes may be ranked according to one or more properties, and the probe that is eliminated from the neighboring probe pair may have the lower ranking. The set of genomic probes may comprise the remaining candidate probes after a pre-determined number of candidate probes have been eliminated.

A variety of computer-related embodiments are also provided. For example, a computer-readable medium containing programming for performing the above probe selection method is provided, as well as a computer containing the computer-readable medium and a method of using the programming to select a set of probes.

The above description is intended to illustrate the general concept of the instant probe selection method. As would be readily apparent, the exact programming for performing those acts may vary greatly.

In one embodiment, the instant probe selection method is an iterative process that includes the following acts: a) weighting regions of a genome segment that contain a feature; b) identifying probes that detect the genome segment; c) calculating the physical distances between probes in neighboring probe pairs; d) adjusting the calculated distances between said probes in the neighboring probe pairs according to the weighting of the region to which a probe pair binds to produce a set of weight-biased distances; e) selecting the neighboring probe pair associated with the least weight-biased distance; f) eliminating the lower ranked probe of the selected probe pair; and g) repeating acts e) to f) until a desired number of candidate probes have been eliminated. In certain embodiments, one or more of the acts are computer-executable.

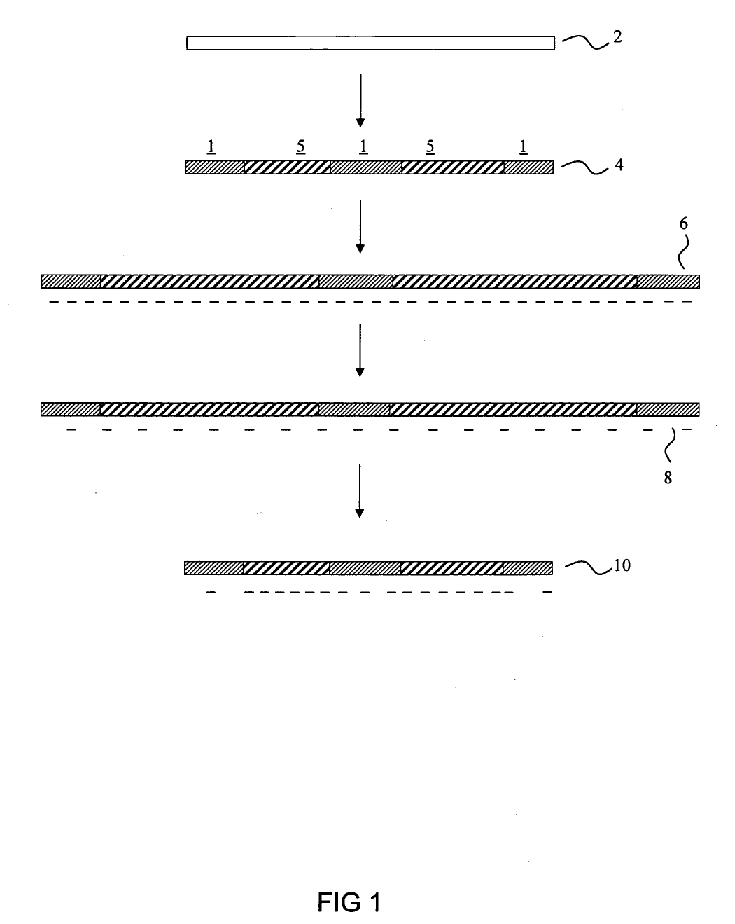

FIG. 1 schematically illustrates an exemplary embodiment. In this embodiment, chromosomal segment 2, which, in certain embodiments, may be in the range of 10 kb to an entire genome in length, e.g., a chromosome arm, an entire chromosome or any locus of a chromosome in length, is analyzed, and one or more regions having a feature or a combination of features are identified (as indicated by the thick hatched regions in FIG. 1). Exemplary regions that contain features include: coding sequences, non-coding sequences, transcribed, non-transcribed, transcribed but not translated, promoters, promoter motifs, DNA binding protein binding sites, CpG islands, miRNA-coding sequences, any arbitrarily chosen sequence element or motif of known or unknown function, sequences that encode a motif in a protein (e.g., a kinase or DNA binding motif), exons, introns, pseudogenes, mRNA-encoding sequences (predicted, hand annotated or experimentally determined), or a gene or any group of genes (e.g., groups of genes that are grouped by function, homology or expression pattern for example) for example. In one embodiment, the region contains a sequence that is found in granted patents, or published patent applications.

Regions having a feature may be identified by any convenient method, e.g., by homology search, computer prediction, motif scanning, or by eye, for example. In particular embodiments, regions having a feature may be identified via a third-party database containing that information. Exemplary third party databases containing information on features include: UCSC's Human Genome database (Kent et al, The Human Genome Browser at UCSC. Genome Res. 2002 12, 996-1006; Karolchik et al, The UCSC Genome Browser Database. Nucl. Acids Res. 2003 31, 51-54), Sanger's microRNA database (Griffiths-Jones et al, miRBase: microRNA sequences, targets and gene nomenclature. Nucl. Acids Res. 2006, 34: D140-D144; Griffiths-Jones, The microRNA Registry. Nucl. Acids Res. 2004 32: D109-D111), and NCBI's GenBank database.

Certain regions may contain a feature and a certain amount of sequence flanking the feature (e.g., in the range of 100 bp to 10 kb) in order that more than one probe for the feature can be selected. For example, certain regions containing a shorter feature, e.g., a feature that is under 1 kb in length such as an miRNA coding sequence or a CpG island, may contain the features and sequences that flank the feature.

Depending on the size of the chromosomal segment analyzed and the feature of interest, the chromosomal segment analyzed may contain about 10 or more, about 100 or more, about 1000 or more, or about 10,000 or more regions, up to about 100,000 or more regions. The regions may vary in size from a single base pair, e.g., in the case of a single methylate CpG dinucleotide to several kilobases, e.g., in the case of large exons of an mRNA coding sequence. For example, many miRNAs are in the region of 15-25 nucleotides in length, wherease certain genes are nearly 3 megabases in length and certain cytobands are up to 10 megabases in length. The chromosomal segment analyzed may contain a fragile site, or a telomere or subtelomeric region, for example. One or many different types of feature may be identified in a single chromosomal segment.

Once regions containing features have been identified, the regions are weighted. In certain embodiments, the regions may be weighted using a number (e.g., an integer), although any suitable weighting system may be employed. As illustrated by element 4 of in FIG. 1, the regions containing the features (shown by thick hatching) are weighted with a “5” (which is an arbitrarily chosen number solely to exemplify this method), whereas the non-feature regions (shown by thin hatching) are weighted with a “1” (e.g., are unweighted).

The general concept of one embodiment of the instant method is illustrated with reference to a weight-adjusted map 6, which is shown in FIG. 1 as map of a chromosomal segment in which the lengths of the regions of the chromosomal segment are increased or decreased relative to their physical length, according to their weighting. For example, in certain embodiments and as shown in FIG. 1, the length of regions having a higher weighting may be increased relative to regions having a lower weighting. In other embodiments, the length of regions having a lower weighting may be decreased in length relative to regions having a higher weighting. As will be described in greater detail below, a weight adjusted map may be produced by a number of ways in silico. For example, in one embodiment, a weight adjusted map may be produced by storing the sequence of the chromosomal segment as well as the boundaries and weightings of the regions within the chromosomal segment, or by storing information about the probes that bind to the chromosomal segment as well as the physical or weight-adjusted distances between their binding sites.

In one exemplary embodiment, the weight-adjusted map may be produced by multiplying the length of a region in a chromosomal segment by its weighting. In particular embodiments, this can be done by multiplying the distance between adjacent probes by the weighting of the region to which the probes bind. As shown in FIG. 1, regions having a higher weighting in physical map 4 are increased in length relative to regions having a lower weighting to produce weight-adjusted map 6.

A set of genomic probes 8 that bind to and can be used to detect the chromosomal segment of interest is obtained (e.g., designed de novo or selected). The genomic probes are obtained using the weight adjusted map of the chromosomal segment. In particular embodiments and as illustrated in FIG. 1, the obtained genomic probes 8 are distributed across the entire genomic segment, and the regions having a higher weighting are associated with a higher number of genomic probes, per base pair, than regions having a lower weighting. Within each region, the probes may be evenly distributed (e.g., distributed such that 70% or more, e.g., at least 90%, of adjacent probes have an inter-probe distance, in base pairs, that is within two standard deviations of the average inter-probe distance for that region).

In certain embodiments, the probes are distributed across the genomic segment such that the spacing between the probes is similar in regions of similar weighting.

In other words, a set of genomic probes is selected such that the physical distance (e.g., the number of nucleotide bases) between adjacent genomic probes is small in higher weighted regions than in lower weighted regions. In one embodiment, the physical distance between two adjacent probes in any particular region may be proportional to the weighting of that region, relative to the physical distance between two adjacent probes in another region that is associated with a different weighting. The probes are evenly spaced in each region, and are more dense in regions having a higher weighting.

As noted above, the probes 8 may be selected from a pre-existing set of candidate probes. The set of candidate probes may contain about 1000 or more probes, e.g., about 5000 or more probes, about 10,000 or more probes, about 20,000 or more probes, about 30,000 or more probes or about 40,000 or more probes, up to about 50,000 probes or 100,000 or more probes., which bind to unique sequences within a genome of interest. In particular embodiments, the set of candidate probes may contain up to 1 billion candidate probes, e.g., over or up to 100,000,000 probes. In certain embodiments, the candidate probes of the set of candidate probes bind to positions that are distributed across the genome being examined. The candidate probes may bind to positions that are distributed across the genome that have an average interval in the range of, for example, every 10 bp to ever 50 bp, every 50 bp to 200 bp, every 200 bp to 500 bp, every 500 bp to 1 kb, every 1 kb to 5 kb or every 5 to 20 kb, or at an interval that is greater than about 20 kb. The probes of the set of candidate probes may be designed to have similar thermodynamic properties, e.g., similar Tms, G/C content, hairpin stability, etc.

In particular embodiments, at least 70% of the candidate probes in the set of candidate probes have a duplex Tm value ranging from about 65° C. to about 85° C., e.g., from about 75° C. to about 85° C., a length in the range of about 40 nucleotides to 70 nucleotides, e.g., about 50 to 65 nucleotides, and a GC content of about 30 to about 50%. Further details of an exemplary candidate probe set that may be employed herein are described in U.S. application Ser. No. 10/996,323, filed on Nov. 23, 2004, which application is incorporated by reference herein in its entirety.

In certain embodiments, the probes of the set of candidate probes may be validated probes in that they have been tested experimentally, e.g., in silico or in a hybridization experiments, and found to provide results that are compatible with future use as a genomic probe. Validated probes may be selected because they provide results that are within the range expected for a suitable genomic probe. The range of results for a suitable genomic probe may be arbitrarily defined or readily determined experimentally or computationally. Suitable genomic probes may produce suitable signal intensities in both channels, exhibit little dye bias, bind stably during washing, and produce signals that persist, for example.

In particular embodiments, the candidate probes may be scored prior to or after selection of genomic probes. In one embodiment, the candidate probes may be scored according one or more or a combination of properties. Such properties, which may be experimentally determined or computationally predicted, include: probe performance properties, including signal intensity when bound to a complementary target sequence, dye bias, susceptibility to non-specific binding, wash stability and persistence of probe hybridization (e.g., during an experiment and/or after stripping an array), evaluation of binding to a plurality of different target sequences (e.g., which may vary by a single base), evaluation of binding to a target gene in a complex sample, comprising, e.g., a whole genome of sequences, slope of a response curve, reproducibility or noise, P-value of separability of distributions based on repeated measurements at two or more target copy number values, variance of signals, variance of ratios, or thermodynamic properties, e.g., duplex melting temperature, hairpin stability, GC content, etc.; and other properties, such as whether a probe binds to an exon, intron, promoter, intergenic region, coding sequence or another other sequence motif. Such scoring may be done by assigning a property score, e.g., an integer, for example, to each of the candidate probes.

In one embodiment, the genomic probes may be selected from the candidate probes by a pairwise probe selection process. This pairwise probe selection process may include selecting the candidate probes that bind to chromosomal segment being examined, and then out of probes that bind to the chromosomal segment being examined, selecting a pre-determined number of genomic probes. The pairwise probe selection process, in certain embodiments, provides for the “best” probes (i.e., those with the highest scores), while maintaining an even distribution of those probes across the weight adjusted map of the chromosomal segment. In one embodiment, the probe selection process is an iterative process that includes the following acts: a) pairing the most proximal probes of the candidate probes according to the weight-adjusted map of the chromosomal segment (i.e., the probes with binding sites that are least distanced according the weight-adjusted map) to produce a probe pair; b) eliminating the lowest ranked probe from the probe pair; and c) repeating acts a) and b) until a pre-determined number of candidate probes have been eliminated. After the pre-determined number of candidate probes have been eliminated, the remaining candidate probes may be employed as genomic probes. Further details of exemplary pairwise selection methods that may be employed herein are described in U.S. application Ser. No. 10/996,323, filed on Nov. 23, 2004, which application is incorporated by reference herein in its entirety.

Alignment 10 of FIG. 1 illustrates a physical map of the chromosomal segment under analysis where the regions are drawn in proportion to their actual size, adorned with the genomic probes produced by the above described method. Regions of the chromosomal segment having a higher weighting are associated with a higher density of genomic probes than regions having a lower weighting. In other words, the method provides for a set of genomic probes that has a probe distribution in which regions having a higher weighting are associated with a greater number of genomic probes, per base pair, than regions having a lower weighting.

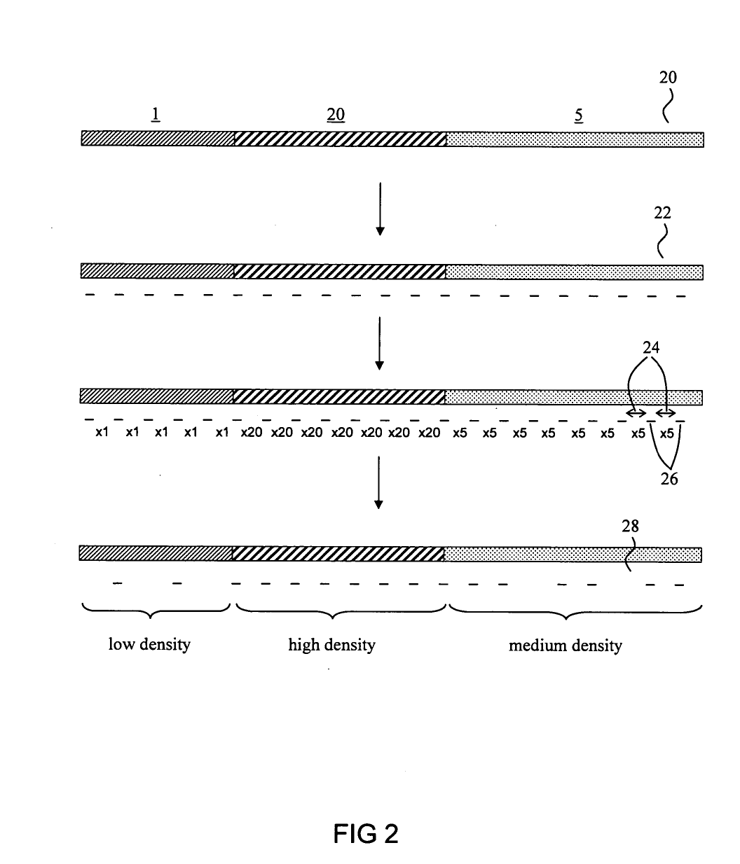

FIG. 2 schematically illustrates a further embodiment of the method. In this embodiment, the above method is performed by a computer in silico. In this embodiment, the weight-adjusted map contains information about the probes that bind to and detect the chromosomal segment under analysis, as well as the distance between neighboring probes, adjusted in accordance with the weighting of the region to which the neighboring probes bind.

In certain cases, regions of a chromosomal segment may be weighted according to the apparent reliability of the evidence that the region contains a particular feature. In one exemplary embodiment, coding sequences within the chromosomal segment are of interest, and potential coding sequence-containing regions of the chromosomal segment are scored according to the source of the information indicating the coding sequence. For example, a chromosomal segment may be scanned to identify regions of sequence identity to expressed sequence tags (ESTs), regions of sequence identity to published cDNA sequences, regions of sequence identity to human-annotated genomic sequences (e.g., protein-coding or miRNA coding sequences) and regions of sequence identity to reverse translated proteins, as well as regions that are predicted by a computer algorithm to be coding sequences because of a particular sequence context. In this example, human annotated experimentally supported coding sequences may be weighted by a relatively high score (e.g., by a 10 on a scale of 1 to 10), sequences showing identity to published cDNAs may be weighted by a relatively intermediate score (e.g., by a 7 on a scale of 1 to 10), and sequences showing identity to ESTs may be weighted by a relatively low score (e.g., by a 4 on a scale of 1 to 10). Coding sequences that are purely predicted by a computer by sequence context, for example, may be weighted with a very low score (e.g., by a 2 on a scale of 1 to 10). Other scoring systems would be readily apparent to one of skill in the art. As noted above, this analysis may be done by a third party, and information on the chromosomal segment of interest may be obtained from the third party source.

In the embodiment shown in FIG. 2, chromosomal segment 20 contains three regions, one weighted by 1, another weighted by a 20, and the other weighted by a 5. Probes 22 that bind to the chromosomal segment 20 are selected from a larger set of candidate probes. The physical distance 24 between neighboring probe binding sites on chromosomal segment 20 is calculated, and is associated with the weighting of the region to which the neighboring probes bind. In this case, as indicated by element 26, the physical distance between the probes of a neighboring probe pair is multiplied by the weighting associated with the probe pair. The weight-adjusted map, in this case, contains primer information and the weight adjusted distances between the neighboring primers. Genomic probes are selected using the weight adjusted map. As discussed above, the genomic probes may be selected so that they are distributed evenly across the chromosomal segment, according their weight-adjusted distances, not their physical distances.

In one exemplary embodiment, the distances between neighboring probes are multiplied by the weighting of the region bound by the probes to produce set of weight-adjusted inter-probe distances. The set of probes is analyzed to identify the neighboring probe pair associated with the shortest inter-probe distance, and one of the probes of the identified probe pair, e.g., the lower ranked probe, is eliminated. This elimination process is repeated until a pre-determined number of probes is eliminated.

As shown by alignment 28, the method provides for a high density of probes for regions associated with a high weighting, a medium density of probes in regions associated with a medium weighting and a low density of probes in regions associated with a low weighting.

In addition to the above, a method of producing an array is provided. These embodiments generally include: a) selecting a first set of genomic probes according to the method described above; and b) fabricating an array comprising those probes, to producing the array.

Arrays can be fabricated using any means, including drop deposition from pulse jets or from fluid-filled tips, etc, or using photolithographic means. Either polynucleotide precursor units (such as nucleotide monomers), in the case of in situ fabrication, or previously synthesized polynucleotides (e.g., oligonucleotides) can be deposited. Such methods are described in detail in, for example U.S. Pat. Nos. 6,242,266, 6,232,072, 6,180,351, 6,171,797, 6,323,043, etc.

Computer-Related Embodiments

A variety of computer-related embodiments are also provided. Specifically, a computer-based method for selecting a set of probes for a genome analysis array using the methods described above, is provided. In one embodiment, the method comprises the following acts: a) inputting information about a feature of a chromosomal segment using a computer interface; and b) executing computer readable instructions for selecting from a larger set of validated probes a sub-set of probes that detect that region, using the method described above. This method may further comprise inputting a desired number of probes. In certain embodiments, the computer readable instructions may be executed locally or remotely to the inputting act

In certain embodiments, the methods are coded onto a computer-readable medium in the form of “programming”, where the term “computer readable medium” as used herein refers to any storage or transmission medium that participates in providing instructions and/or data to a computer for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer.

With respect to computer readable media, “permanent memory” refers to memory that is permanent. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

A computer-based system comprising the above-referenced computer readable medium is also provided. The minimum hardware of the computer-based systems of the present invention comprises a central processing unit (CPU), input means, output means, and data storage means. A skilled artisan can readily appreciate that any one of the currently available computer-based system are suitable for use in the present invention. The data storage means may comprise any manufacture comprising a recording of the present information as described above, or a memory access means that can access such a manufacture.

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

A “processor” references any hardware and/or software combination that will perform the functions required of it. For example, any processor herein may be a programmable digital microprocessor such as available in the form of a electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

In another embodiment, a computer-based method for selecting a set of genomic probes is provided. This method may comprising: inputting a feature and a chromosomal segment; and executing computer readable instructions for performing the method described above, to select said set of genomic probes. The executing may be done locally or at a remote location to the inputting act. In particular embodiments, the chromosomal segment and/or feature may be selected using a graphical user interface. The method may further comprise receiving information on the set of genomic probes produced by the method.

The programming may be designed to run on a “stand-alone” computer in that the programming may be installed and operated, with user input, in a single computer or computer system, e.g., on a Microsoft Windows operating system. In another embodiment, the computer programming may be executed at a location that is remote to the use's location. In this embodiment, the user may enter information into a graphical user interface at a workstation, and the information is transferred via the world wide web to a computer at which the programming is executed.

In other embodiments, the programming may provide a link to a third-party database, such as University of California, Santa Cruz's genome database (Kent et al, The Human Genome Browser at UCSC. Genome Res. 2002 12, 996-1006; Karolchik et al, The UCSC Genome Browser Database. Nucl. Acids Res. 2003 31, 51-54), Sanger's miRNA database, or NCBI's Genbank database to obtain genomic coordinates based on user input. In this case, the user may provide a gene symbol, the computer program will then retrieve coordinates from the third party database, and execute the instant programming using the coordinates, in order to provide a probe set for the gene, for example.

In particular embodiments and as exemplified by the “tracks” at U.C. Santa Cruz's genome database, a third party database may have categorized features by their type, e.g., whether they are EST-predicted, hand-annotated, exons, miRNA-encoding, cDNA-encoding, RefGene sequences, etc. As such, in performing the methods, in addition to a chromosomal segment, a user may also select a category of feature, e.g., a track, from a third party database. Selection of the category of feature in addition to a chromosomal segment allows information for a plurality of features to be obtained and processes using the methods described above.

In other words, a user may also provide a feature-type identifier, e.g., a track identifier, indicating the type of feature of interest. Information about the features associated with that track identifier can be retrieved from a third party database, and probes can be designed to the features associated with the identifier, e.g., features present on the track. The user may also specify which third party databases and/or track identifier may be utilized to generate a weight-adjusted map. These tracks may or may not be the same as the tracks specified for probe selection. Selection of genomic segments and features may also be done using a graphical user interface, and the user may be able to input preferences, weightings, flanking sequences, and identifiers for features. As an output, the programming may produce the sequences of a set of probes for the chromosomal segment under examination. In certain embodiments, the programming may provide information on the density of the selected probes, the scores of the selected probes, or the types of the selected probes. This information may be displayed graphically.

The above-described methods allow arrays for genome analysis, e.g., for comparative genome hybridization, identification of DNA binding protein binding sites, investigation of methylation status or analysis of CpG islands, to be designed by a number of different means. In one embodiment, a custom array may be designed by a client at remote location to a vendor. The custom array may be ordered from the vendor by the client, and shipped to the client from the vendor. In addition to designing the array, the client may also receive the array. In another embodiment, a number of different clients may design arrays at a remote to the vendor. The vendor may gather information on which features are of most interest to the clients, and produce an off the shelf array that contains probes for those features, using the methods described above.

Further embodiments are described below.

In one embodiment, the invention relates to methods for selecting probes for an assay, such as a genome-scanning assay. As used herein, a “genome-scanning” assay refers to a method which evaluates binding of a biomolecule of interest (e.g., a DNA molecule or protein molecule or other biomolecule) to sequences distributed at one or more chromosomes of the genome, two or more chromosomes, three or more chromosomes, four or more chromosomes and up to at least about 25% of the chromosomes of the genome, at least about 50%, or at least about 100% of the chromosomes of the genome of an organism, e.g., such as a mammal and more particularly, such as a human being.

In one aspect, array sequences are selected which are designed to probe a complex target mixture, such as a sample of genome sequences which are not otherwise reduced in complexity. The probe sequences selected for a gene of interest can be selected from a sequence ranging from about 100 to 50,000 or may be greater than about 50,000 bases (e.g., 100,000 bases or more).

Arrays including such probes are also encompassed within the scope of the invention as are computer program products (e.g., software or hardware, etc) for implementing the methods. Systems for operating the computer program products and for communicating (either directly or indirectly), e.g., such as through an interface (e.g., a GUI), with a device or system or facility for fabricating an array (e.g., such as an oligonucleotide deposition system or ink jet printer) or are also encompassed within the scope of the invention. In certain aspects, the interface is remote from the device or system or facility for fabricating the array.

The array produced using the above methods contain a set of probes for a chromosomal segment of a genome. Depending on the design of the array and how many probes may present on the array, a portion of the probes on the array may be normalization probes, and the remainder of the probes may be probes for the analysis of the chromosomal segment. In certain embodiments, at least 10%, at least 20%, at least 30%, at least 40%, at least 50%, at least 60%, at least 70%, at least 80%, up to about 90% of the probes on a subject array may be normalization probes and the remaining probes may be probes for the chromosomal segment.

At least the probes of a subject array may possess similar thermodynamic properties.

A significant number (e.g., at least 60%, at least 70%, at least 80%, at least 90%, at least 95%, at least 98% or at least 99%) of the at least the probes of a subject array possess a duplex Tm value which falls within a narrow Tm distribution or Δ™ of about 0.25° C. to about 5° C., e.g., about 0.25° C. to about 3° C., or 0.25° C. to about 2° C. ΔTm is defined as a temperature distribution in which Tm median is approximately in the center of the distribution. Probes which are within the delta Tm may have a duplex Tm greater than the median Tm−(delta Tm)/2 but less than median Tm+(delta Tm)/2. Most of the melting temperatures spanned by the delta Tm usually fall within the temperature range of about 65° C. to about 90° C. when calculated by the method described in J Breslauer et al. Proc Natl Acad Sci. (PNAS) 1986 June; 83(11): 3746-3750, where the target and probe concentrations are both 0.1 pM and the salt concentration term is set equal to zero.

A significant number (e.g., at least 60%, at least 70%, at least 80%, at least 90%, at least 95%, at least 98% or at least 99%) of at least the probes have a duplex Tm value ranging from about 65° C. to about 85° C., e.g., from about 75° C. to about 85° C. or from about 78° C. to about 82° C. Tm values for a particular probe may varying due to the salt concentration in the probe solution, target concentration, probe concentration as well as other factors. In one embodiment, the percent of normalization probes on an array which have a duplex Tm value between 65° C. to about 85° C. is in the range of about 90% to about 100%. In another embodiment, the percent of probes on an array which have a duplex Tm value between 75° C. to about 85° C. is about 90% to about 99%.

In certain embodiments, the probes have a nucleotide length ranging from about 20 nucleotides to about 100 nucleotides, usually about 40 nucleotides to 70 nucleotides, and more usually about 50 to 65 nucleotides in length. In some embodiments all the probes on the array have the same length, for example a length of about 60 nucleotides. In other embodiments the about 40% to about 60% of all the probes have a length of 60 nucleotides.

In certain embodiments, a significant number (e.g., at least 60%, at least 70%, at least 80%, at least 90%, at least 95%, at least 98% or at least 99%) of at least the probes possess similar GC content, which may, in certain embodiments, fall within a narrow % GC distribution or delta % GC of less than about 10%, e.g., less than about 5%, or less than about 3%. In one embodiment, about 60% to about 99% of the probes have a % GC content from the range of 30% to 40%. In another embodiment, about 60% to about 95% of the probes have a % GC content from the range of 34% to 40%. In yet another embodiment, about 70% to about 90% of the normalization probes have a % GC content from the range of 34% to 40%.

The probes of an array may, in certain embodiments, bind to sequences that are evenly distributed across each region. In certain embodiments (and dependent on experimental design) no two probes of a subject array bind to genomic sequences that are less than about 100 bp, about 500 bp, about 1 kb, about 5 kb or about 10 kb apart.

In one embodiment, probes are selected to represent a plurality of sequences in the genome, i.e., probes are selected which are complementary to the plurality of sequences and can hybridize to the sequences under stringent hybridization conditions. In one aspect, the probe sequences comprise sequences associated with genes. Such sequences can include coding regions, transcribed regions and/or regulatory sequences which when bound to a biomolecule (e.g., such as a polypeptide or nucleic acid) controls the expression of the gene (e.g., causes transcription initiation, enhancement or suppression). In certain aspects, probes are selected to represent every RefSeq transcript, as mapped to the genome. In one aspect, about 30,000 genes are represented by probes on the array. In another aspect, probes on the array include sequences that include at least a portion (e.g., at least about 8 bases, at least about 10 bases, at least about 20 bases, at least about 60 bases, at least about 100 bases) of coding sequences from at least about 25%, at least about 50%, or at least about 100% of genes in the genome (which in certain aspects, numbers about 30,000 genes). In a further aspect, probes include intergenic regions. As used herein, the term “intergenic region” refers to a sequence between the transcription initiation site of a first gene and a transcription termination site of an upstream gene (e.g., 5′ of the first gene). As used herein, an intergenic region can include a promoter and/or other regulatory sequence (e.g., such as an enhancer region) associated with a gene. Generally, an intergenic region does not include coding sequences. In certain aspects, generally, an intergenic region does not include a transcribed but untranslated region or intron sequences.

In certain embodiments, the number of features corresponds to at least the number of genes in a genome being evaluated. In other aspects, the numbers of features is at least about 50% of the number of genes, at least about 100%, at least about 130%, at least about 150%, at least about 200%, or at least about 300% of the number of genes in a genome. In one aspect, an array according to the invention includes at least about 44,000 features. In another aspect, an array according to the invention includes at least about 185,000 features.

In certain embodiments, an array according to the invention comprises both coding and intergenic regions. In other embodiments, an array according to the invention comprises intergenic regions, coding regions and/or transcribed by not translated regions. In one embodiment, each gene represented on an array is represented by a plurality of different sequence probes. In certain aspects, at least a portion of the probes on the array include Expressed Sequence Tag (EST) sequences or sequences corresponding to “lesser-quality transcripts.” Such sequences include those which represent putative transcripts (based on sequence characteristics, e.g., such as the presence of open reading frames, etc.) or single-read EST/cDNA sequences, etc. In contrast, “high quality transcripts” as used herein refer to transcripts for which there has been some human curation, validation, etc., such as RefSeq transcripts.

In another embodiment, probe sequences are selected which include probes spaced at non-uniform (e.g., unequal) intervals (e.g., in terms of numbers of bases) along a chromosome of a genome.

In certain aspects, when intergenic regions are included on an array in addition to coding regions, the intergenic region probes are selected by applying an algorithm that weighs both spacing and probe quality (e.g., as measured by in silico or empirically derived methods). For example, suitable algorithms as described in U.S. patent application Ser. No. 10/996,323, filed Nov. 23, 2004 may be used.

Arrays also can be designed by selecting probes from a database of probes. In one aspect, such a database includes probes spaced at approximately 500 base pairs along a chromosome of a genome of interest (e.g., such as the human genome). To design an array from this database, i.e. to select a subset of probes, the user inputs a desired density of probes (i.e. the desired spacing between probes), and a set of genomic regions or a set of gene identifiers (which are internally mapped to genomic regions). Then, a computer program applies an algorithm such as mentioned above to select probes that have good probe quality and are relatively evenly spaced.

However, in another aspect, a probe selection method according to the invention takes into account the size of a gene, e.g., the number of bases of genomic DNA including introns and untranslated regions used to generate a transcript corresponding to that gene. In a further aspect, the selection method accounts for the distance between the genomic regions a user desires to have represented on an array and/or overlap between them (e.g., particularly if neighboring or overlapped regions have different desired densities). In still a further aspect, the selection method permits a user to select a probe from a database that allows a small distance outside of an initially selected region to be considered, for example, if that probe outside of the initially selected region is of higher quality than the probes within the region.

Criteria for probe quality can include: computational and/or empirically-determined properties such as melting temperature, GC content, self-structure (e.g., predicted tendency to form secondary structures such as hairpins), homology or lack thereof to predetermined sequences and/or other probe sequences, target specificity (e.g., the ability to uniquely identify a sequence in a sample, such as ability to uniquely identify one chromosome vs. another, one gene vs. another, one species vs. another), inclusion of repetitive sequences, presence or lack of restriction enzyme recognition sites, complexity, and/or other criteria to enable a user to predict which probes will provide good signals and/or will not cross-hybridize in an assay (e.g., an array-based assay, such as aCGH, location analysis, expression analysis, genotyping, haplotype evaluation, and the like) in which the probe will be used.

In certain aspects, for example, where, empirically-determined properties are used to determine probe quality, such properties can include but are not limited to: signal intensity when bound to a complementary target sequence, dye bias, susceptibility to non-specific binding, wash stability and persistence of probe hybridization (e.g., during an experiment and/or after stripping an array), evaluation of binding to a plurality of different target sequences (e.g., which may vary by a single base), evaluation of binding to a target gene in a complex sample, comprising, e.g., a whole genome of sequences, slope of a response curve, reproducibility or noise, P-value of separability of distributions based on repeated measurements at two or more target copy number values, variance of signals, variance of ratios, etc.

In one aspect, the weight given to a particular criteria can be selected by a user, established as a system default in a system described further below, and/or provided as a recommendation by the system to the user. Further, in certain aspects, where a particular application is identified to the system by the user (e.g., where probes are selected for a aCGH assay vs. an expression analysis assay), the system can weight probes using criteria identified as generally optimal for that application.

In one embodiment, the invention provides a method to select probes for a genome scanning array (e.g., such as a whole genome array) or for arrays that are intended to address many genes, regions, and features of interest (including those of transcriptomes). It allows consideration of an unlimited number of features. It permits soft transitions to be made between regions, thus enabling probes close to regions to be considered when their quality is high. It executes quickly, allowing parameter modifications to be explored.

In one embodiment, an exemplary workflow is as follows:

Consider a single chromosome C, of length LC basepairs. (e.g. human chromosome 1, at 245 million basepairs).

Now consider a set of high-quality transcripts, H1, H2, H3, . . . , HN which have known alignment to chromosome C. Let these transcripts have lengths LH1, LH2, LH3, . . . , LHN. These transcripts may overlap.

Consider also a set of lower-quality transcripts, L1, L2, L3, . . . , LN which have known alignment to C, with lengths LL1, LL2, LL3, . . . , LN. These transcripts may overlap, and may overlap the high quality transcripts.

The biologist/marketing specification for the optimal use of probes to learn about this chromosome and genes is to:
Cover the high quality transcripts with at least 3 probes each, and cover them with probes at density D1.
Cover the lower quality transcripts with probes at density D2.
Cover the rest of the chromosome with probes at density D3.

In this context, to “cover” means to place probes within the gene bounds (in certain cases defined by the transcription start and termination site), or very close. In all circumstances, even spacing of probes is desirable, but weight must be given to probe quality as well.

In one embodiment, the following steps are taken:
Construct an occupancy vector for each set of transcripts for a sequence or genomic region (e.g., such as a chromosome) of interest. This vector marks each base position along the chromosome as true or false, where “true” means that the base lies inside the gene bounds of one or more transcripts.
Assign a comparative weight to each set of transcripts (e.g., based on quality).
Construct a quantitative occupancy vector; each base is given the value of the most heavily weighted occupancy vector that is set to true at that base position.
Now, when selecting probes, the distance between two probes is not calculated strictly by the number of bases between them; rather, each base is counted with the value of the occupancy vector.

The effect of this method is that, in regions with high weights, probes will end up spaced relatively close together, while in regions of lower weight, the probes will be further apart. By appropriately adjusting the weights, the desired densities D1, D2, and D3 can be achieved. No special accounting is required for areas that are multiply covered. Separate computations do not need to be performed for many intervals. Probes that are very close to a gene can be included, and can be preferred if they are of high quality, because the use of a weighting does not create a sharp boundary between gene and intergenic space.

Some additional features of the algorithm:
If desired, a smoothing function can be applied to the quantitative occupancy vector. This will further blur the boundary between genes and intergenic space, allowing high quality probes close to genes (e.g., such as in intergenic regions) to be chosen over lower quality probes inside the gene boundaries.
To achieve replicate coverage of genomic features (in the example above, triplicate coverage of high quality transcripts), additional weighting factors can be applied per gene. For example, if the unweighted spacing of probes is 10 kilobases, and a weighting factor of 2 is applied, then the spacing will become 5 kilobases. If a gene is only 5 kilobases long, then it will only have one probe; hence, and additional weighting factor of 3 should be applied to this gene. Alternatively, if probes close to the gene but not within a gene boundary are as valuable as probes inside the gene boundaries, the region with a weighting of 2 could be extended by 5 kilobases in either direction, thus ensuring that three probes are chosen within close proximity to the gene.

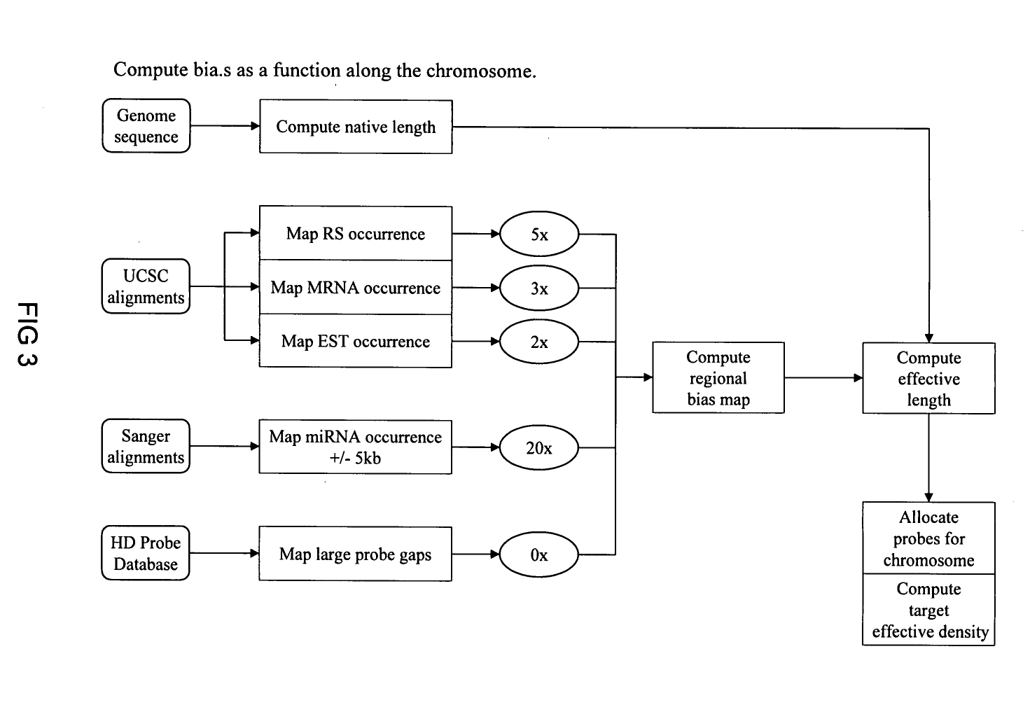

FIGS. 3 and 4 are flow charts representing steps of the method according to one aspect of the invention. As shown in FIG. 3, in certain aspects, bias is computed as a function along the length of a chromosome of interest. One or more sequence databases can be evaluated: e.g., such as, but not limited to, a species gene sequence database (e.g., a database comprising sequence information for genome sequences from a particular species, such as a human being), a sequence alignment database (e.g., such as a database which provides data relating to aligned sequences within a species, e.g., human self-alignment sequence data, or data relating to inter-species alignments, e.g., such as alignments between two or more species) such as the USCS genome browser database, databases for coding and/or non-coding RNA sequences, high definition probe databases (e.g., such as databases comprising sequences that tile selected genomic regions, spaced at about 100, 200, 400, or 500 bases on average), and the like.

Alignments can also be evaluated by obtaining the sequences (e.g. for RNA coding sequences, such as RefSeq from NCBI) and using programs such as BLAT or BLAST to align the sequences against the genome sequence.

In one aspect the method includes one or more steps of: computing the length of a sequence of interest (e.g., such as a chromosome sequence), mapping RefSeq occurrence, mapping mRNA occurrence, mapping EST occurrence, mapping small RNA occurrence (e.g., such as miRNA occurrence), mapping large probe gaps, or mapping other units of organization within a sequence region. Mapping can be performed by obtaining data from one or more databases and in certain aspects, mapping is performed using data from at least about two databases. In another aspect, the method includes the step of computing a regional bias map. This may be factored into data relating the length of the sequence of interest to compute an effective length. In still another aspect, the method comprises allocating probes for a sequence of interest, such as an entire chromosome sequence and computing target effective density, e.g., to ensure replicate coverage which is at least about one-fold, at least about two-fold, at least about three-fold, at least about four-fold, or at least about five-fold, for particular sets of target sequences that are mapped onto of the genome sequence, depending on user preference or a system default.

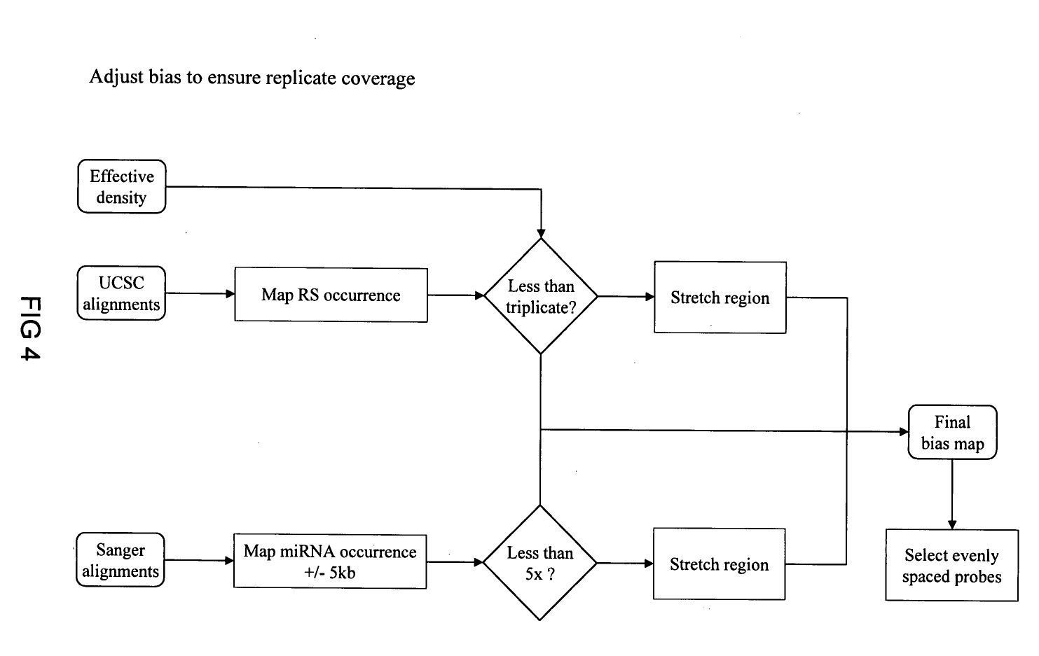

In certain aspects, as shown in FIG. 5, a method according to the invention includes steps of aligning sequences of interest (e.g., such as high and/or low quality transcript sequences) to a genomic region being scanned (e.g., a chromosome sequence), evaluating the spacing of candidate probes according to their spacing measured directly in base pairs and modified by the values in the regional bias map for the region between the two probes selecting candidate probes (subsequences along the genomic region being scanned, such as a chromosome sequence) with maximum scores based on the spacing evaluation and additional metrics that measure the quality of the probe, and/or user established and/or system established parameters. The method will then return to the user the best set of probes according to these criteria.

As discussed above, the invention provides probe sets identified by the methods (e.g., selected probes). In certain aspects, the probe sets are provided as compositions of nucleic acids (e.g., provided on an array or in solution). In other aspects, the probe sets are provided as sequence information stored in a computer readable memory. In one aspect, the computer readable memory communicates with a computer program product which executes instructions for displaying a representation of the probe sequences.

In further aspects, a computer program product allowing a user to implement all steps of a method according to the invention is provided. The computer program product can be run on a system, e.g., such as a computer processor. In some aspects, the computer program product includes software that can run standalone. In other aspects, the computer program product includes software that is provided on the web and the computer processor is connectable to a network. Additionally, the software may link a system according to the invention to third party databases, such as sequence databases, e.g., such as the UCSC genome browser database, to enable a user to obtain genomic coordinates based on user input. For example, a field may be provided to allow a user to input and text associated with a genomic region of interest (e.g., to input “chromosome 1”) or a user may be provided with a menu of selectable options (e.g., names of chromosomes) or a graphical representation of such options (e.g., images of chromosomes).

In one aspect, inputting or selecting a first selection criterion allows a user to identify a genomic region of interest (e.g., chromosome 1), links a user to one or more databases comprising sequence information relating to the genomic region of interest, and provides a user with additional selection options for that region of interest (e.g., to select RefSeq probes, miRNA probes, and/or other candidate probe sequences of interest). In certain aspects, a user is provided the option to select from one or more annotation tracks, e.g., such as known genes, predicted genes, ESTs, mRNAs, (e.g., such as the UCSC mRNA and EST tracks), CpG islands, chromosomal bands, homologies to other species, UCSC RegGene track, consensus sequences (e.g., such as the Consensus Coding Sequence project (CCDS) track), mammalian genes (e.g., such as the MGC track), EnsGEne track, miRNA track (e.g., such as from Sanger miRNA GFF files). In certain aspects, optionally, redundant sequences identified are removed from consideration.

A variety of selection options may be provided as described above: e.g., a user can be provided with input fields, a dropdown menu, a list of options which can be checked to identify one or more options of interest, a graphical representation of options, etc. In certain aspects, a user can input weighting factors, extensions around genomic features, for example, to direct the system to display additional candidate probes for a region (e.g., candidate probes that may be farther from a gene of interest than other candidate probes but which may have advantageous properties, such as desired thermodynamic properties, in an assay to be performed with the probes). Probe sequences identified may discrete and/or overlapping sequences.

In certain aspects, the positions of transcription units or other markers along the genomic region of interest can also be displayed, e.g., such as the position of microsatellite repeats, positions of probes that have been empirically tested, sites of chromosomal abnormalities (e.g., deletions, duplications, rearrangements of sequences), polymorphic sites, protein binding sites, sites of high quality vs. low quality transcripts, methylation sites, etc. In certain aspects, these positions may be represented as vertical or horizontal bars and/or by text. Other indicia of interest to a user selecting probes may also be provided for example, the score or weight of a candidate probe may be indicated by a color coding scheme or in some other way. In certain aspects, probes which correspond to intergenic regions are represented differently (e.g., by different colors or shadings) from probes which correspond to transcribed regions and/or coding regions.

In one embodiment, the system executes a computer program product (e.g., software) which provides feedback to a user of achieved density for a group of candidate probes. Additional data can be displayed such as summary statistics based on identifiers or tracks. Statistics can include, but are not limited to: probe densities, scores of probes or categories of probes.

In other aspects, selecting a candidate probe and/or a region of a chromosome displays, on at least a portion of a graphical user interface accessible to a user selecting probes, additional information about the probe and/or region of the chromosome. For example, selecting a probe can cause the system to display data relating to properties of the probe, such as, but not limited to: sequence information, thermodynamic properties, empirical data, expression data, polymorphisms (single base pair changes, deletions, insertions, rearrangements, etc) at the sequence to which the probe corresponds and/or disease associations with those polymorphisms.

In certain aspects, a user can add as a criteria for selection of probes: a particular disease association, a protein binding site at a sub-region of a genomic region being scanned, RNA expression values, allele information, alternative exon splicing data, copy number variation at a site, microsatellite instability at a site, presence of motifs and/or consensus sequences in a region, etc. In other aspects, a user can input negative criteria: e.g., directing the system to filter (remove from a candidate probe list or representation, or cause the system not to display such probes at all) out candidate probes with certain criteria (e.g., correspondence to a repeat region, a gene desert, etc.). In one aspect, the system displays whether the probe sequence is associated with a patent (e.g., by displaying a patent number or other representation of the patent). In another aspect, selecting the representation of the patent causes the system to display on the user interface a display of claims for the patent.

In one embodiment, a user can store versions of selections of candidate probes and in certain aspects, a plurality of users to a system can modify one or more versions if provided appropriate permissions. For example, in certain aspects, a user can identify probes that have been empirically tested in an assay to other users having access to a shared version.

In certain aspects, the invention also provides an array comprising one or more probes or probe sets identified by a method according to an aspect of the invention. The microarray can be a custom microarray, designed by a user or a plurality of users selecting particular genomic regions of interest or a catalog array. In one aspect, a catalog array is selected based on input from a plurality of users of the system and probes may be selected from one or more versions of selections of candidate probes. Data relating to probes for such a catalog array can be saved in a memory of the system. In certain aspects, users with appropriate permissions can modify such probes (e.g., based on new annotation information, empirical testing, or for other reasons). In further aspects, the memory can include data relating to array layouts containing such probes.

In still further aspects, a user can select a probe set meeting desired criteria and input an order for the probe set which is communicated to a site remote from the user which can accept or refuse the order. In certain aspects, when the site entity accepts the order, the probe set is synthesized and provided to the user. In certain aspects, the probe set is provided on an array. Thus, in one aspect, arrays generated according to methods such as described above are encompassed within the scope of the invention. The array can cover all or a portion of the genome and all or a portion of a chromosome.

Systems according to aspects of the invention may include both hardware and software components, where the hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms represented of the system.

The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows NT®, Sun Solaris, Linux, OS/400, Compaq Tru64 Unix, SGI IRIX, Siemens Reliant Unix, and others.

In certain embodiments, the subject devices include multiple computer platforms which may provide for certain benefits, e.g., lower costs of deployment, database switching, or changes to enterprise applications, and/or more effective firewalls. Other configurations, however, are possible. For example, as is well known to those of ordinary skill in the relevant art, so-called two-tier or N-tier architectures are possible rather than the three-tier server-side component architecture represented by, for example, E. Roman, Mastering Enterprise JavaBeans™ and the Java™2 Platform (John Wiley & Sons, Inc., NY, 1999) and J. Schneider and R. Arora, Using Enterprise Java. (Que Corporation, Indianapolis, 1997).

It will be understood that many hardware and associated software or firmware components that may be implemented in a server-side architecture for Internet commerce are known and need not be reviewed in detail here. Components to implement one or more firewalls to protect data and applications, uninterruptable power supplies, LAN switches, web-server routing software, and many other components are not shown. Similarly, a variety of computer components customarily included in server-class computing platforms, as well as other types of computers, will be understood to be included but are not shown. These components include, for example, processors, memory units, input/output devices, buses, and other components noted above with respect to a user computer. Those of ordinary skill in the art will readily appreciate how these and other conventional components may be implemented.

The functional elements of system may also be implemented in accordance with a variety of software facilitators and platforms (although it is not precluded that some or all of the functions of system may also be implemented in hardware or firmware). Among the various commercial products available for implementing e-commerce web portals are BEA WebLogic from BEA Systems, which is a so-called “middleware” application. This and other middleware applications are sometimes referred to as “application servers,” but are not to be confused with application server hardware elements. The function of these middleware applications generally is to assist other software components (such as software for performing various functional elements) to share resources and coordinate activities.

Other development products, such as the Java™2 platform from Sun Microsystems, Inc. may be employed in the system to provide suites of applications programming interfaces (API's) that, among other things, enhance the implementation of scalable and secure components. Various other software development approaches or architectures may be used to implement the functional elements of system and their interconnection, as will be appreciated by those of ordinary skill in the art.

Additional system components, methods, arrays and kits may be include as are described in U.S. patent application Ser. No. 11/001,700, filed Nov. 30, 2004, U.S. patent application Ser. No. 11/001,672, filed Nov. 30, 2004 and U.S. patent application Ser. No. 11/000,681, filed Nov. 30, 2004, the entireties of which are incorporated by reference herein.

Methods of using microarrays according to embodiments of the invention are also encompassed. Accordingly, binding of a surface-bound polynucleotide to a labeled population of nucleic acids may be assessed. In most embodiments, the assessment provides a numerical assessment of binding, and that numeral may correspond to an absolute level of binding, a relative level of binding, or a qualitative (e.g., presence or absence) or a quantitative level of binding. Accordingly, a binding assessment may be expressed as a ratio, whole number, or any fraction thereof.

In other words, any binding may be expressed as the level of binding of a surface-bound polynucleotide to a labeled population of nucleic acids made from a non-cellular chromosome composition, divided by its level of binding to a labeled population of nucleic acids made from a reference chromosome composition (or vice versa).

The following examples are offered by way of illustration and not by way of limitation.

### EXPERIMENTAL

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

Exemplary parameter settings for an exemplary method according to one embodiment are set forth below:

RefGene, CCDS, MGC:
Stretch 4.5.
Genomic extension+/20 kb.

mRNA
Stretch factor 2.5.
No extension.

EST
Stretch 1.5.
No extension.

miRNA
Stretch 10.
Extension+/−20 kb

Ignore gaps>4*nominal spacing when computing chromosome lengths.

Adjust for multiple coverage in RefGene:
Check for triplicate coverage within gene bounds+/−5 kB.
Set stretch up to 6.
Extend 6-fold stretch to achieve triplicate.

Smooth with 20 kb boxcar.

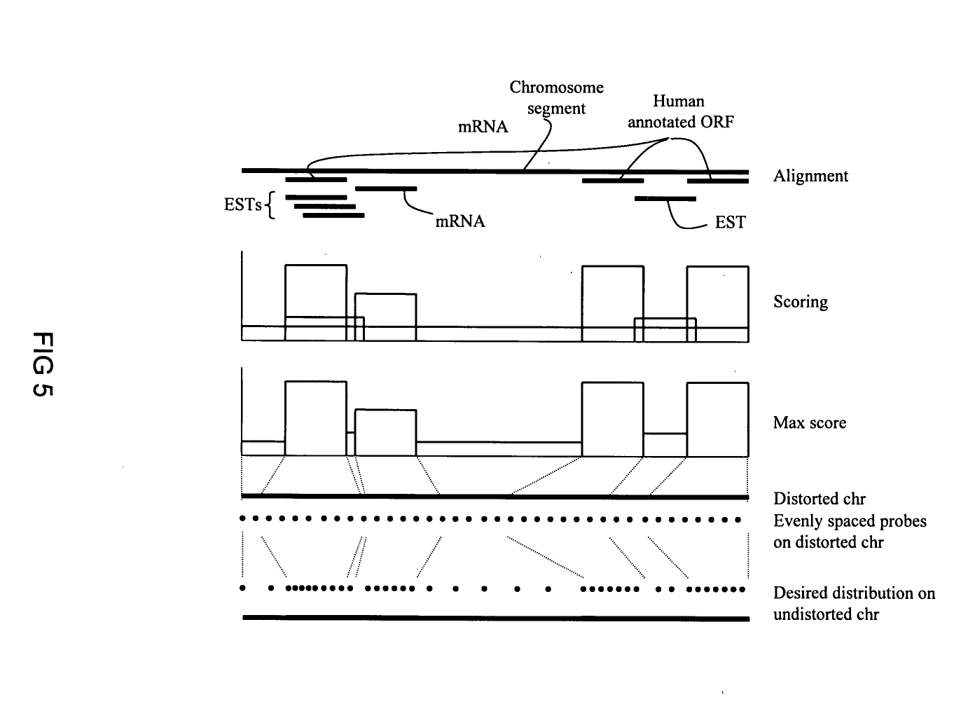

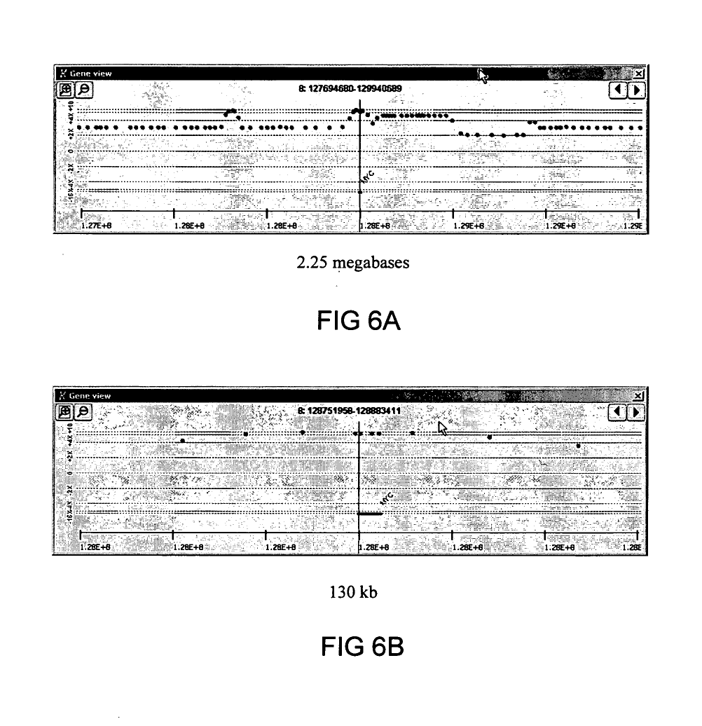

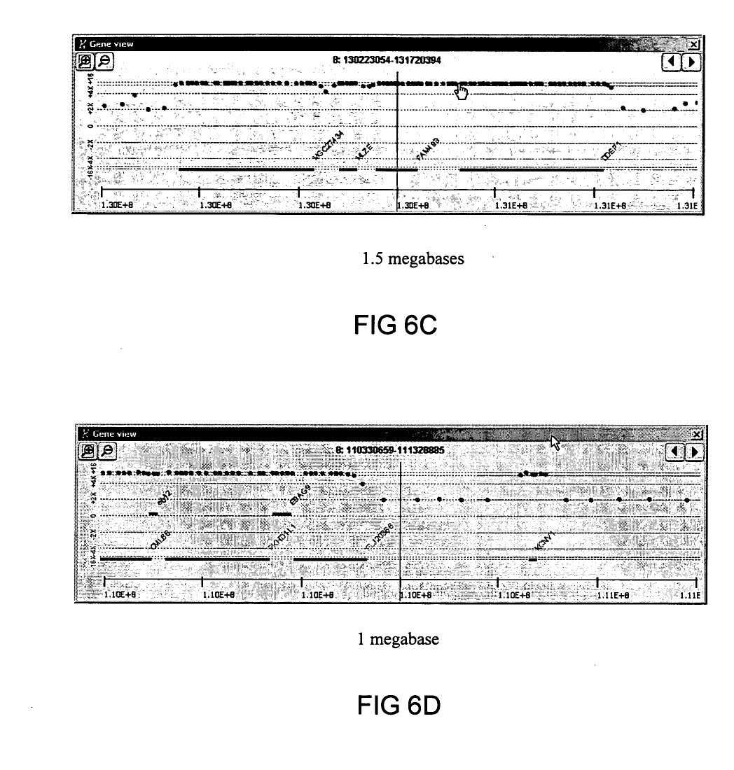

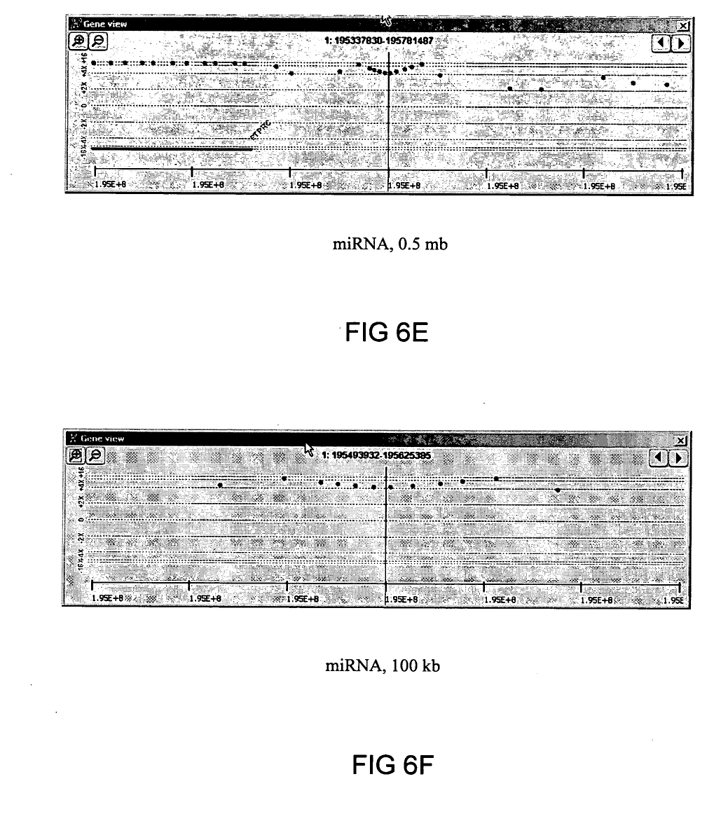

FIGS. 6A-6F illustrate typical probe distributions obtained in accordance with the above-described methods.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the invention.

What is claimed is:

1. A method for selecting a set of genomic probes, comprising:
a) weighting regions of a chromosomal segment that contain a feature to produce a weight-adjusted map of said chromosomal segment; and
b) selecting a set of probes for said at least part of a genome using said weight-adjusted map;
to select said set of genomic probes.

2. The method of claim 1, wherein said set of genomic probes is selected such that regions having a higher weighting are associated with a higher density of genomic probes than regions having a lower weighting.

3. The method of claim 1, wherein said set of genomic probes is selected from an initial probe set that containing a larger number of probes than said set of genomic probes.

4. The method of claim 3, wherein said set of genomic probes is selected from said initial probe set using a pairwise probe elimination method.

5. The method of claim 1, wherein said feature is a genomic feature.

6. The method of claim 5, wherein said genomic feature is a regulatory feature.

7. The method of claim 6, wherein said regulatory feature is a CpG island or promoter region.

8. The method of claim 5, wherein said genomic feature is a transcribed or coding sequence.

9. The method of claim 8, wherein said coding sequence is a miRNA coding sequence, an EST coding sequence, an exon encoding a known cDNA, or a predicted exon.

10. The method of claim 5, wherein said regions are individually weighted according to strength of evidence indicating a genomic feature at that region.

11. The method of claim 1, wherein said at least part of a genome is 1 Mb or longer of a genome.

12. A computer-readable medium comprising:
programming for performing the method of claim 1.

13. The computer readable medium of claim 12, wherein said method includes:
a) weighting regions of a genome segment that contain a feature;
b) identifying probes that detect the genome segment;
c) calculating the physical distances between probes in neighboring probe pairs;
d) adjusting the calculated distances between said probes in the neighboring probe pairs according to the weighting of the region to which a probe pair binds to produce a set of weight-biased distances;
e) selecting the neighboring probe pair associated with the least weight-biased distance;
f) eliminating the lower ranked probe of the selected probe pair; and
g) repeating acts e) to f) until a desired number of candidate probes have been eliminated.

14. A computer system comprising:
the computer-readable medium of claim 12.

15. A computer-based method for selecting a set of genomic probes, comprising the following acts:
inputting information about a feature of a chromosomal segment using a computer interface; and,
executing computer readable instructions for performing the method of claim 1;
to select said set of genomic probes.

16. The computer-based method of claim 15, wherein said executing act is done locally to said inputting act.

17. The computer-based method of claim 15, wherein said executing act is done at a remote location to said inputting act.

18. The computer-based method of claim 17, wherein said method comprises retrieving information from a location that is remote to the locations in which the inputting and executing acts are performed.

19. The computer-based method of claim 15, wherein said inputting includes specifying a type of feature, and said method further includes retrieving from a third party database information on a plurality of features of the specified type.

20. The computer-based method of claim 15, wherein said inputting includes specifying a type of feature and a chromosomal segment, and said method produces a set of genomic probes for a plurality of features of the specified type in said chromosomal segment.

21. The computer-based method of claim 15, wherein said regions each comprise a feature and flanking sequences at either side of said feature.

22. The computer-based method of claim 15, wherein said inputting act includes selecting said pre-determined sequence determination using a graphical computer interface.

23. The computer-based method of claim 15, further comprising receiving information on said set of genomic probes.

24. The computer-based method of claim 15, further comprising receiving an array comprising said set of genomic probes.

25. A method of making an array, comprising:
a) selecting a set of genomic probes according to the method of claim 1; and
b) fabricating an array comprising said set of genomic probes.

26. An array made by the method of claim 25.

27. A method comprising:
making an array according to the method of claim 25;
contacting said array with a population of labeled nucleic acids; and
reading said array to produce data.
